(19) United States
(12) Patent Application Publication
(10) Pub. No.: US 2004/0238433 A1
(43) Pub. Date: Dec. 2, 2004

(54) Filter assemblies with compressible filtering medium

(76) Inventor: Paul Clark, Luton Beds (GB)

Correspondence Address: BARNES & THORNBURG, P.O. BOX 2786, CHICAGO, IL, 60690-2786, US

(21) Appl. No.: 10/487,524

(22) PCT Filed: Aug. 21, 2002
(86) PCT No.: PCT/GB02/03855

(30) Foreign Application Priority Data
Aug. 23, 2001 (GB) 01202525.1

(51) Int. Cl. B01D 33/00

(52) U.S. Cl. 210/356

(57) ABSTRACT

A filter assembly has a compressible filtering medium (18, 19) disposed in the flow path of water from the upstream region of an inlet chamber (11) to a downstream outlet (17). Said compression of the filter medium by the water passing through the filter assembly increases the proportion of the overall flow path of water constituted by a low resistance portion of the flow path. The clogging of the filter medium thus leads to an increase in water pressure in the upstream region which, in turn, causes compression of the filter medium, which compression tends to increase the water flow rate through the outlet so as to counter the reduction in water flow rate causes by the clogging.

This invention relates to filter assemblies for filtering water, for example pond or aquaria water.

According to the invention there is provided a filter assembly for filtering a flow of water, the assembly comprising a container enclosing an inlet chamber with an upstream region and a downstream outlet, and a filter medium in a water flow path between the upstream region and the downstream outlet, wherein the filter medium is elastically compressible so that an increase in water pressure in the upstream region as a consequence of clogging of the filter medium causes the filter medium to be compressed in a movement which tends to increase water flow rate through the outlet so as to counter the reduction in water flow rate caused by the clogging.

Preferably the filter medium comprises a plurality of bodies of open-celled foam material, with the bodies being of decreasing cell size, and therefore decreasing coarseness, in the direction of the water flow path so that as clogging progresses the movement of the filter medium causes a greater proportionate area of the coarser foam material to be presented to the outlet. In one preferred embodiment, there are two bodies of foam material which abut along an interface, the movement of the filter medium on clogging causing this interface to move with respect to the outlet so that progressively more of the coarser foam body is presented to the outlet. Thus, as clogging progresses, the water flow path passes through in one of the low resistance paths presented by the coarser foam material.

Alternatively, it is possible for the filter medium to consist of a homogenous body of open-celled foam material of uniform cell size, because particles become trapped in the foam body, with the result that the movement of the filter medium on clogging causes progressively more of the compressed so that water can pass to the outlet through a portion of the body that offers relatively low resistance to the through flow of water, or directly to the outlet without having been subjected to any significant degree of mechanical filtering.

Preferably, the inlet chamber is annular, the filter medium is annular and the outlet is formed in a central tubular body surrounded by the filter medium. The tubular body may have plurality of circumferentially spaced slots constituting the outlet.

The filter medium provides a mechanical filtering action which may be supplemented by ultra-violet treatment of the water and/or biological treatment by exposure to bacteria. For example, the filter assembly may include a source of ultra-violet radiation to which the flow of water is exposed after passage through the outlet. Also, the filter assembly may include a compartment, downstream of the outlet and upstream of the ultra-violet source, accommodating plastics granules for attracting bacteria so as to provide biological treatment of the water.

Preferred embodiments of the invention will now be described, by way of example, with reference to the accompanying drawings, in which:

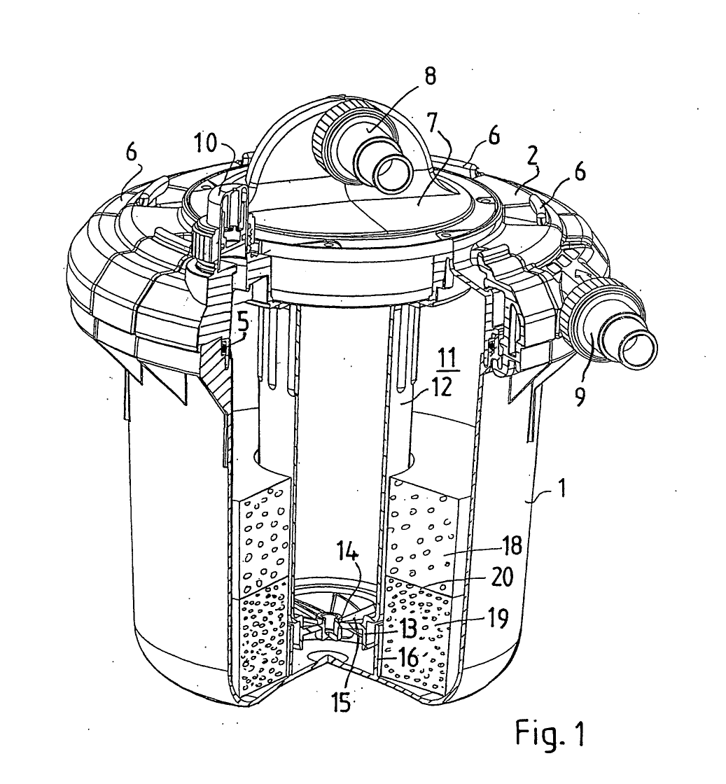

FIG. 1 is an isometric view of the first embodiment of the filter assembly according to the invention,

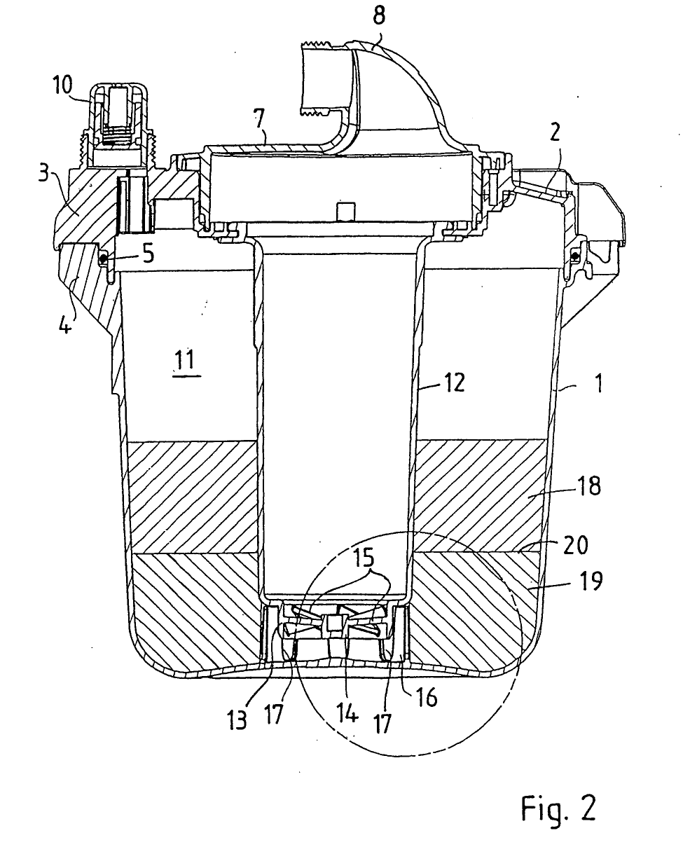

FIG. 2 is a sectional view, on a central plane, of the filter assembly of FIG. 1,

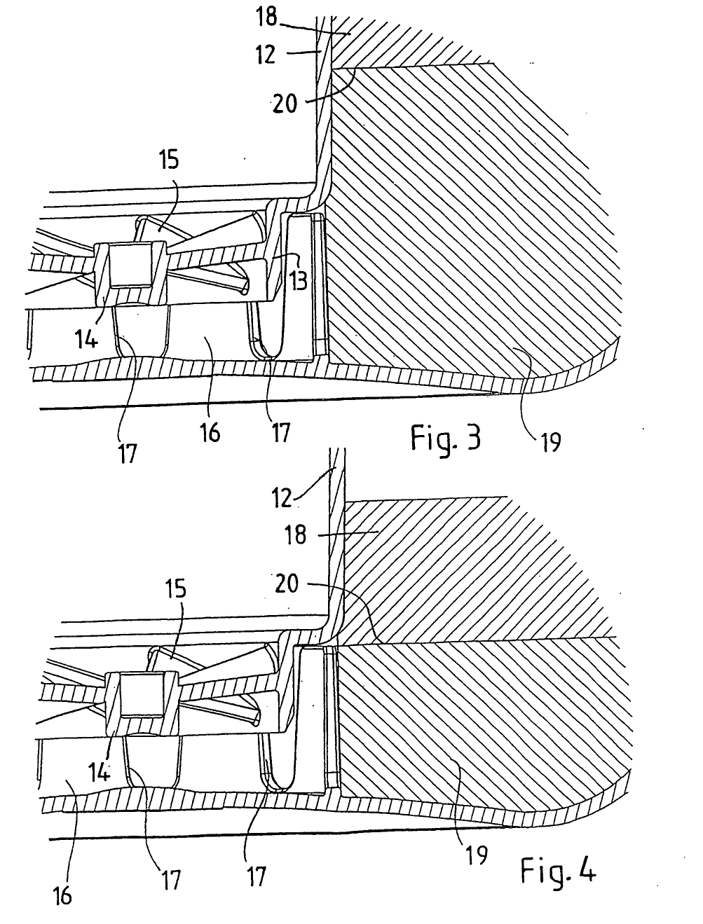

FIGS. 3, 4 and 5 are sectional views, on an enlarged scale, of the circled area of FIG. 2, showing three successive stages in the condition of a foam filter medium of the assembly of FIGS. 1 and 2,

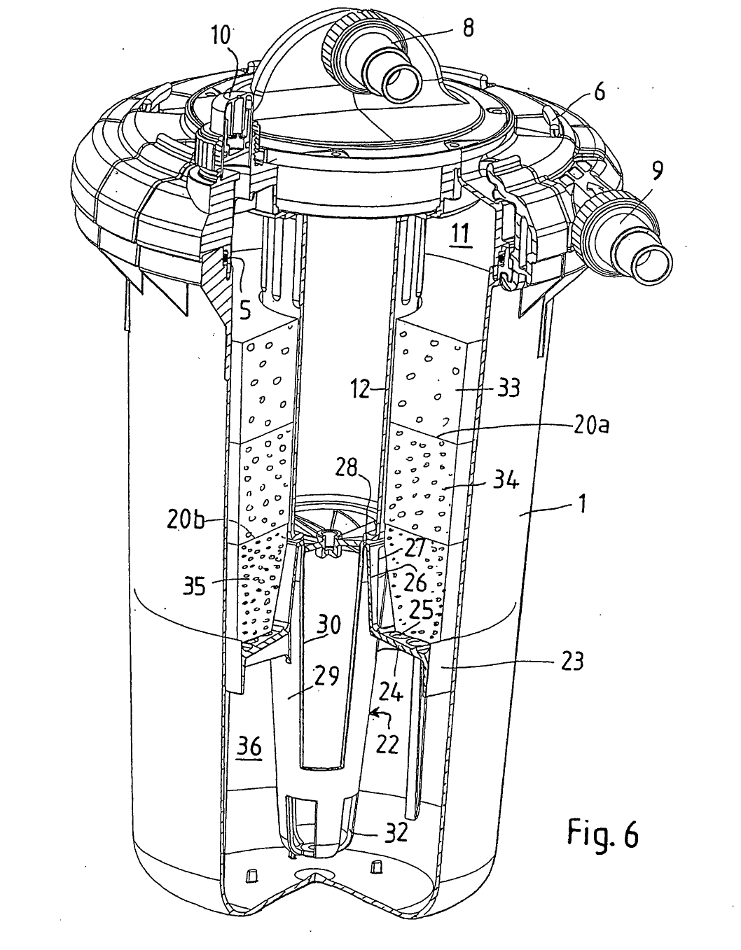

FIG. 6 is an isometric view of the second embodiment of filter assembly according to the invention,

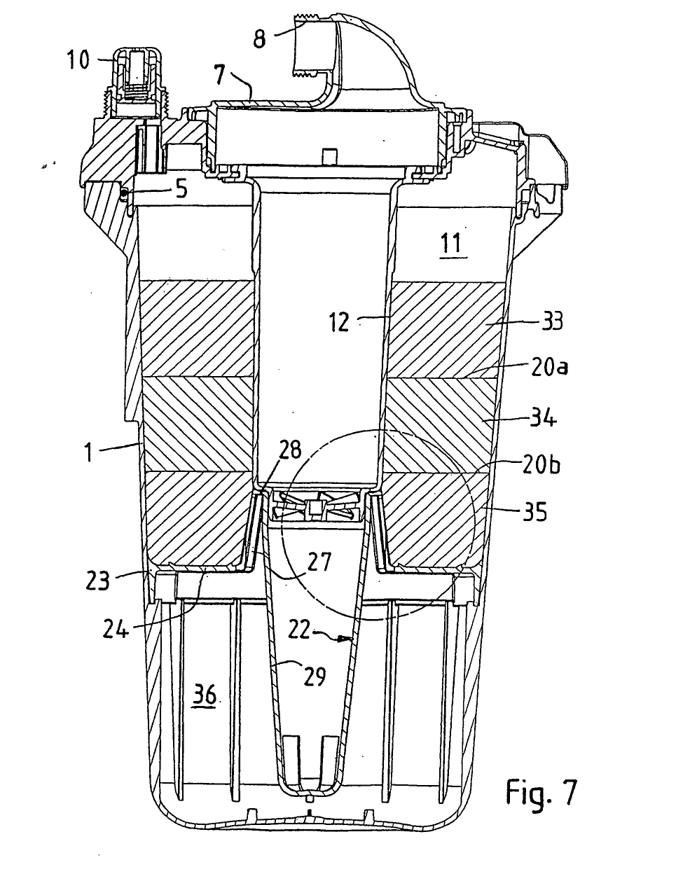

FIG. 7 is a sectional view, on a central plane, of the filter assembly of FIG. 6,

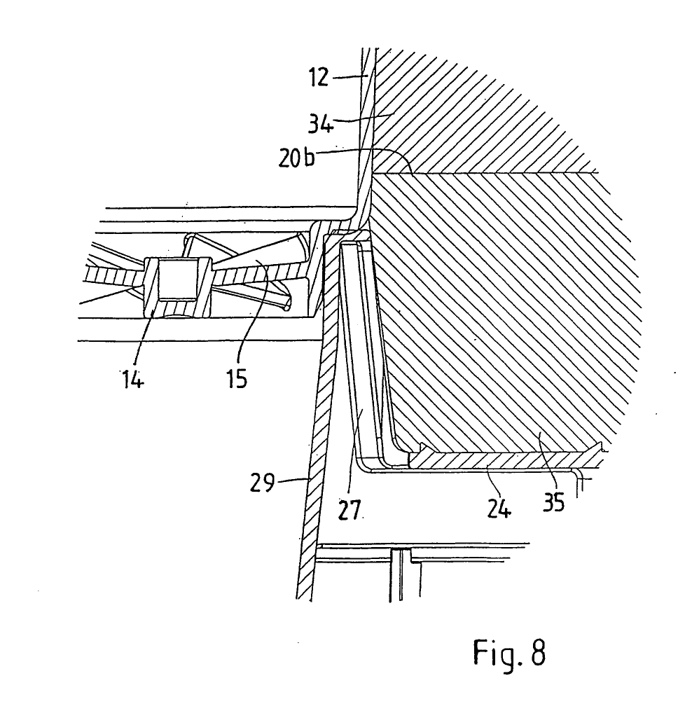

FIGS. 8, 9 and 10 are sectional views, on an enlarged scale, of the circled area of FIG. 7, showing three successive stages in the condition of a foam filter medium,

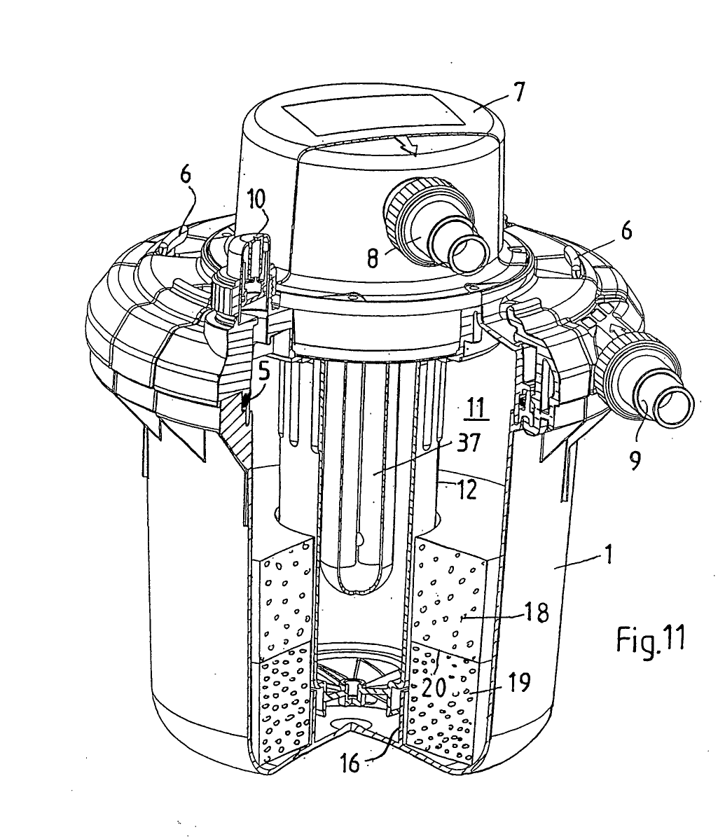

FIG. 11 shows a modification of the filter assembly of FIGS. 1 and 2, and

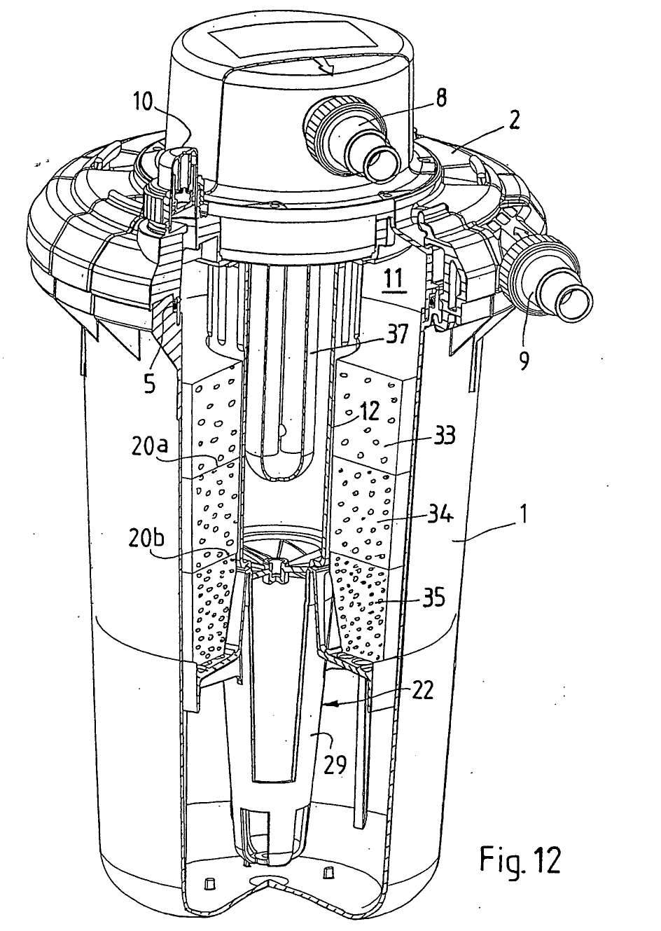

FIG. 12 shows a modification of the filter assembly of FIGS. 6 and 7, and

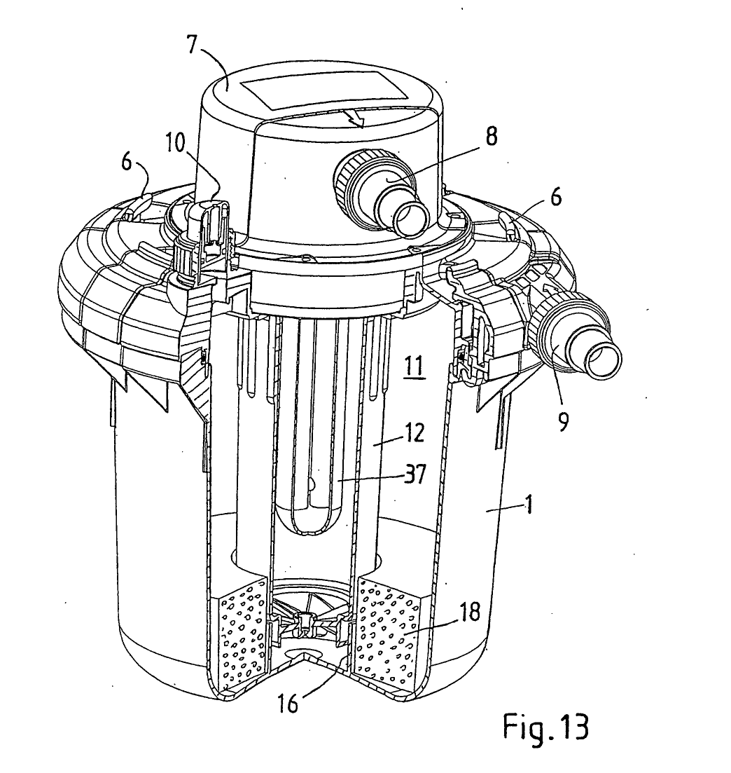

FIG. 13 is an isometric view of the third embodiment of filter assembly according to the invention.

Referring principally to FIGS. 1 and 2, the filter assembly comprises a container formed by a plastics body 1 the upper end of which is closed by a plastics lid 2. The body and lid 2 have respective external flanges 3, 4 which make sealing engagement with the aid of an intervening O-ring 5. The flanges 3, 4 are detachably clamped together by a series of circumferentially spaced toggle clamps 6. This enables the lid 2 to be removed from the body 1 or to be replaced and sealed thereon. The lid 2 supports a central housing 7 carrying a moulded outlet duct 8. The lid 2 has an integrally moulded inlet duct 9 which admits water to an inlet chamber 11 of the container in a tangential direction. The lid 2 also carries a valve 10 which may serve as a safety valve or an indicator valve to indicate when pressure in the inlet chamber 11 exceeds a predetermined threshold. The housing 7 is shown in different angular positions in FIGS. 1 and 2, although the housing 7 is normally fixed in angular position with respect to the body 1.

Depending from the lid 12 is a central hollow tube 12 the lower end of which terminates in an open end defined by a reduced diameter skirt 13 surrounding a central hub 14 connected to the skirt 13 by a plurality of circumferentially spaced angled vanes 15 having spaces therebetween. The lower end of the tube 12 projects downwardly into the circular region defined by an annular wall 16 projecting upwardly from the base of the body 1. The annular wall 16 is formed with a plurality of circumferentially spaced vertical slots 17 which define an outlet for the chamber 11. Between an upstream region of the chamber 11 and the slots 17 are disposed two layers 18, 19 (or any convenient number of layers) of filter material each in the form of an annular body of open-celled plastics foam material which is elastically or resiliently compressible. The upper layer 18 is coarser than the lower layer 19, i.e. the upper layer 18 has larger cells at a larger spacing than the lower layer 49.

In use, a supply of the water to be filtered is pumped (e.g. from a garden pond) into the inlet duct 9 and an outlet pipe for the delivery of filtered water is attached to the outlet duct 8. The inlet duct 9 causes the incoming flow of water to enter the upstream region of the inlet chamber 11 in a tangential direction and the resulting swirling or vortex movement causes any large particles in the water flow to be deposited in the inlet chamber. The water then passes downwardly through the upper filter layer 18 and then the lower filter layer 19, before passing through the slots 17 and thence through the spaces between the angled vanes 15 so as to reach the inside of the tube 12 and the outlet duct 8. The angled vanes 15 impart a rotational or swirling movement to the water as it passes upwardly through the tube 12.

Initially, both layers 18, 19 of foam are in a clean condition and the interface 20 between the foam layers is positioned as illustrated in FIGS. 1, 2 and 3. After a period of use, the filter medium starts to become clogged and the lower filter layer 19 tends to clog before the upper filter layer 18 because the lower filter layer 19 is finer. This initial clogging causes the pressure in the upstream region of the inlet chamber to increase and this pressure bears on the upper surface of the upper foam layer 18 and compresses both foam layers 18, 19 so that the interface 20 between the foam layers is lowered, as illustrated in FIG. 4. The compression of the foam layers 18, 19 exposes proportionately more of the coarser upper layer 18 to the slots 17 and tends to increase the water flow rate through the slots 17 so as to counter the reduction in water flow rate caused by the progressive clogging. Thus, the compression of the filter medium compensates, to some extent, for the reduction in flow rate caused by the clogging.

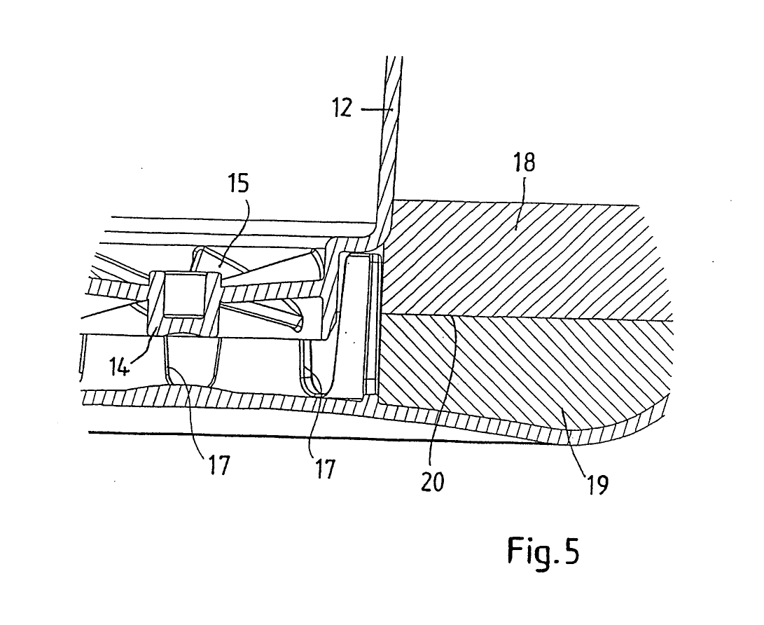

As clogging proceeds, the filter medium becomes further compressed and FIG. 5 illustrates how the interface 20 between the foam layers 18, 19 has moved downwardly across the upper part of the faces of the slots 17 so as to increase the by-pass effect which, as before, counters the reduction in water flow rate caused by the clogging. The attainment of a maximum working threshold pressure in the inlet chamber 11 may be indicated by the valve 10, to indicate to the user that the filter medium requires cleaning.

FIG. 6 corresponds to FIG. 1 but shows a second embodiment of filter assembly having a larger capacity container. Similar parts in all the Figures bear the same reference numerals. The assembly of FIGS. 6 and 7 incorporates an internal support body 22 having an external flange 23 attached to the body 1, a radial wall 24 having circular apertures 25 therein, an upwardly converging frusto-conical wall 26 which is formed with elongated slots 27, an annular ridge 28 and a downwardly converging frusto-conical portion 29 formed with a series of larger slots 30 and a series of smaller slots 32 at its extreme lower end. There are three layers 33, 34, 35 of foam of progressively decreasing coarseness in a downwards direction. The two interfaces are referenced 20a and 20b, the lower layer 35 resting on the wall 24 and, at its radially inner annular surface, abutting the wall 26.

In use, the volume of the container between the lower part of the body 1 and the support body 22 defines a compartment 36 which is filled, or substantially filled, by plastics granules (not shown) having a high surface to volume ratio. The lid 2 is applied to the body 1 and sealed thereon. As before, a supply of water to be filtered is pumped into the inlet duct 9 and an outlet pipe for the delivery of filtered water is attached to the outlet duct 8. The incoming water enters the inlet chamber 11, passes through the three layers 33, 34, 35 of foam material and thence through the slots 27 which form the downstream outlet of the chamber 11. Water also passes through the apertures 25. The water then passes through the compartment 36 where it is subjected to biological treatment as a result of the build-up of bacteria on the plastics granules. Thereafter, the water passes through the slots 30, 32, passes upwardly within the tube 12 and leaves the assembly through the outlet duct 8.

FIG. 8 (corresponding to FIG. 3), shows the interface 20b between the lower foam layer 35 and the intermediate foam layer 34 when the foam is in a clean condition.

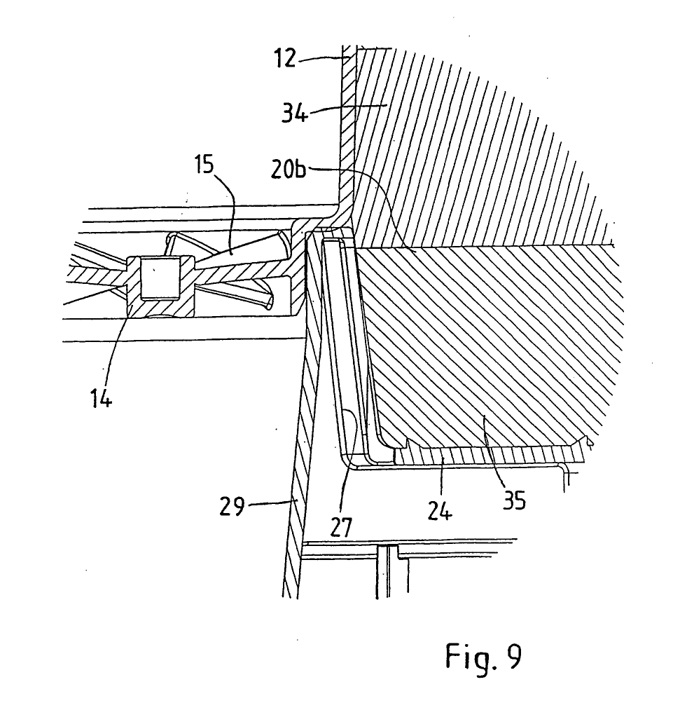

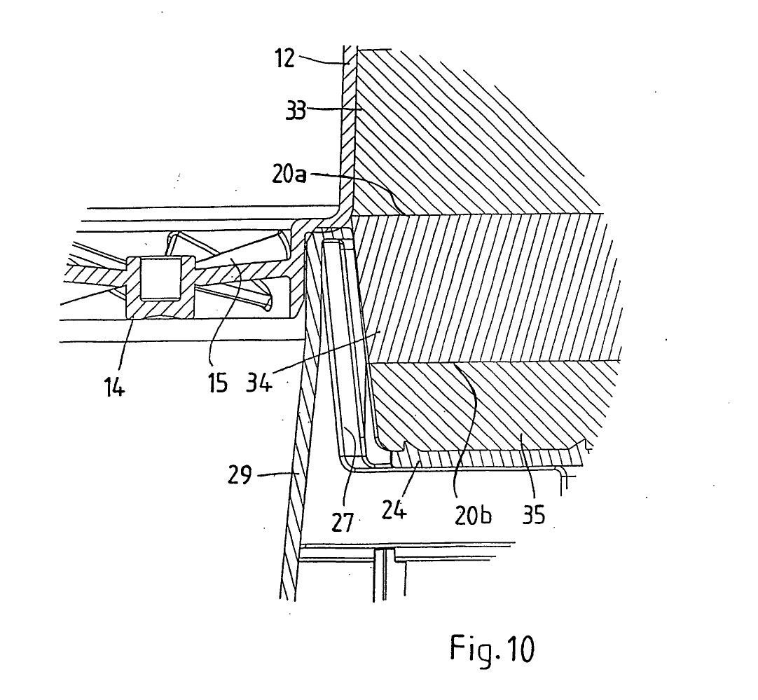

As the foam layers start to clog, the increase in pressure in the inlet chamber 11 causes the filter layers to be compressed so that the interface 20b moves to the position shown in FIG. 9 which corresponds to FIG. 4. After further use and further clogging, the filter layers 33, 34, 35 are further compressed as shown in FIG. 10 which illustrates the slots 27 fully open to the resistance path presented by the coarser layer.

FIG. 11 illustrates a modification of FIG. 1. The modification involves the inclusion in the central tube 12 of a source 37 of ultra-violet radiation past which the water flows as the water proceeds up the central tube 12. In comparison with FIG. 1, the housing 7 of FIG. 11 is enlarged to incorporate the means for electrical supply to the ultra-violet source 37. The vanes 15 provide a shield, preventing a user looking directly at the source 37 even if the lid 2 is removed from the assembly (with the tube 12 attached).

Similarly, FIG. 12 represents a modification of the assembly of FIG. 6. In FIG. 12 the central tube 12 accommodates a source 37 of ultra-violet radiation past which the water flows as it proceeds up the central tube 12.

The filter assembly of FIG. 13 has a single homogenous annular body 18 of foam: otherwise the filter assembly is identical to the assembly illustrated in FIG. 11. In use, the lower regions of the body 18 can become clogged with debris before the upper region of the body 18, so the result is similar to the two-layer assembly of FIG. 1. Alternatively, the top layer of the body could become clogged before its lower regions, in which case the body would be compressed to expose the outlet and thus allow water to pass directly into the outlet without travelling through the filter.

In all the described embodiments, the clogging of the filter medium is utilised to reduce the resistance to flow with progressive compression of the filter medium.

1. a filter assembly for filtering a flow of water, the assembly comprising a container enclosing an inlet chamber with an upstream region and a downstream outlet, and a filter medium in a water flow path between the upstream region and the downstream outlet, wherein the filter medium is elastically compressible so that an increase in water pressure in the upstream region as a consequence of clogging of the filter medium causes the filter medium to be compressed in a movement which tends to increase water flow rate through the outlet so as to counter the reduction in water flow rate caused by the clogging:

2. An assembly according to claim 1, in which said compression of the filter medium causes movement of said medium relative to the outlet so that water in a portion of said flow path of water encounters a reduced resistance to flow from the inlet chamber to the outlet.

3. An assembly according to claim 1 in which an increase in the extent of said movement of the filter medium causes a corresponding increase in the total cross sectional area of said reduced resistance portion.

4. A filter assembly according to claim 1, in which the filter medium comprises a plurality of bodies of open-celled foam material, with the bodies being of decreasing cell size, and therefore decreasing coarseness, in the direction of the water flow path so that as clogging progresses the movement of the filter medium causes a greater proportionate area of the coarser foam material to be presented to the outlet.

5. A filter assembly according to claim 4, in which there are two bodies of foam material which abut along an interface, the movement of the filter medium on clogging causing this interface to move with respect to the outlet so that progressively more of the coarser foam body is presented to the outlet.

6. A filter assembly according to claim 1, in which the filter medium consists of a homogenous body of open-celled foam material of uniform cell size, the arrangement being such that the movement of the filter medium on clogging causes progressively increasing compression of the filter medium so that water can pass to one of: the outlet through a portion of the body that offers relatively low resistance to the through flow of water, and directly to the outlet without having been subjected to any significant degree of mechanical filtering.

7. A filter assembly according to claim 1, in which the inlet chamber is annular, the filter medium is annular and the outlet is formed in a central tubular body surrounded by the filter medium.

8. A filter assembly according to claim 7, in which the tubular body has a plurality of circumferentially spaced slots constituting the outlet.

9. A filter assembly according to claim 1, in which the filter assembly includes a source of ultra-violet radiation to which the flow of water is exposed after passage through the outlet.

10. A filter assembly according to claim 1, in which the assembly includes a compartment, downstream of the outlet and upstream of the ultraviolet source, accommodating plastics granules for attracting bacteria so as to provide biological treatment of the water.

11. A filter assembly according to claim 1, in which the downstream outlet is a bypass outlet and the inlet chamber includes a second downstream outlet therefrom, the bypass outlet and the second downstream outlet arranged such that flow through the bypass outlet bypasses at least some of the filter medium and the second downstream outlet.

12. A filter assembly according to claim 11, and including a compartment arranged to receive flow from the second downstream outlet, and to communicate flow to the bypass outlet, wherein the second chamber includes material therein for attracting bacteria for biological treatment of the water.

13. A filter for filtering a flow of water, the filter including a housing that defines a chamber having a flow inlet thereto and a flow outlet therefrom, the filter further including a filtration medium positioned in the chamber at least partly in a flow path from the inlet to the outlet so as to filter that flow, wherein the filtration medium is resistantly-compressible such that increasing water pressure on the inlet side of the filtration medium due to at least partial blocking of the filtration medium causes the filtration medium to become compressed such that at least part of the filtration medium moves relative to the outlet so as to reduce resistance by the filtration medium to flow through that outlet.

14. A filter assembly for filtering a flow of water, the assembly comprising a container enclosing an inlet chamber with an upstream region and a downstream outlet, and a filter medium in a water flow path between an upstream region and the downstream outlet, wherein the filter medium is elastically compressible so that an increase in water pressure in the upstream region as a consequence of clogging of the filter medium causes the filter medium to be compressed in a movement which tends to increase water flow rate through the outlet so as to counter the reduction in water flow rate caused by the clogging, wherein the filter medium comprises two bodies of open-celled foam material, with the bodies being of decreasing cell size, and therefore decreasing coarseness, in the direction of the water flow path and wherein the two bodies of foam material abut along an interface, and the movement of the filter medium on clogging causes this interface to move with respect to the outlet so that progressively more of the coarser foam body is presented to the outlet.

15. A filter assembly for filtering a flow of water, the assembly comprising a container enclosing an inlet chamber with an upstream region and a downstream outlet, and a filter medium in a water flow path between an upstream region and the downstream outlet, wherein the filter medium is elastically compressible so that an increase in water pressure in the upstream region as a consequence of clogging of the filter medium causes the filter medium to be compressed in a movement which tends to increase water flow rate through the outlet so as to counter the reduction in water flow rate caused by the clogging, wherein the filter medium consists of a homogenous body of open-celled foam material of uniform cell size, the arrangement being such that the movement of the filter medium on clogging causes progressively increasing compression of the filter medium so that water can pass to the outlet through a portion of the body that offers relatively low resistance to the through flow of water.

16. A filter assembly for filtering a flow of water, the assembly comprising a container enclosing an inlet chamber with an upstream region and a downstream outlet, and a filter medium in a water flow path between an upstream region and the downstream outlet, wherein the filter medium is elastically compressible so that an increase in water pressure in the upstream region as a consequence of clogging of the filter medium causes the filter medium to be compressed in a movement which tends to increase water flow rate through the outlet so as to counter the reduction in water flow rate caused by the clogging, wherein the filter medium consists of a homogenous body of open-celled foam material of uniform cell size, the arrangement being such that the movement of the filter medium on clogging causes progressively increasing compression of the filter medium so that water can pass directly to the outlet without having been subjected to any significant degree of mechanical filtering.
